(19) United States
(12) Patent Application Publication
(10) Pub. No.: US 2008/0158510 A1
(43) Pub. Date: Jul. 3, 2008

(54) Apparatus And Method For Displaying Information Within A Vehicle Interior

(75) Inventors: Therese A. Tant, Royal Oak, MI (US); Thomas A. Seder, Northville, MI (US); Wade W. Bryant, Grosse Pointe Farms, MI (US); James T. Embach, Rochester Hills, MI (US); Judy Y. Kim, Howell, MI (US); Benjamin Walsh, Ampthill (GB); Kelly G. Craigo, Harper Woods, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/952,442

(22) Filed: Dec. 7, 2007

Related U.S. Application Data
(60) Provisional application No. 60/883,108, filed on Jan. 2, 2007.

(51) Int. Cl. G03B 21/00

(52) U.S. Cl. 353/14

(57) ABSTRACT

An apparatus for displaying information within a vehicle interior includes a surface having a coating for emitting visible light when excited by an ultraviolet (UV) light beam, and a laser projection device (LPD) for generating and directing the UV light beam onto the coating to display information on the surface. The LPD generates one or more UV laser beams, and the coating has one or more light-emitting layers each excitable by a different UV wavelength. Each layer emits a different color of light when excited. The surface is a transparent windshield or lens, or an opaque surface. A method for displaying information within a vehicle interior includes applying a light-emitting coating to a surface in at least one layer, and generating and projecting a UV light beam onto the coating to present information in at least as many colors as there are layers.

### CLAIM OF PRIORITY

This application claims priority to U.S. Provisional Patent Application No. 60/883,108, filed on Jan. 2, 2007, which is hereby incorporated by reference in its entirety.

### TECHNICAL FIELD

The present invention relates to a display system for use in a vehicle interior, the display system having a laser projection device and a surface having at least one light-emitting layer, with a light beam projected by the laser projection device that selectively illuminates a light-emitting layer or layers to cause information to be displayed on the surface.

### BACKGROUND OF THE INVENTION

The instrument panel of an automotive vehicle contains various gauges, instruments, warning lights, and other indicator devices each providing useful information to a user of the vehicle, for example information regarding the current status and/or condition of an associated vehicle system. Speedometers, tachometers, and fuel gauges are a few of the more common and prominently positioned vehicle indicators or gauges, respectively providing accurate and instantaneous readings of vehicle speed, engine speed, and the amount of fuel remaining in the fuel tank. Vehicle gauges are commonly configured as analog barrel-style devices having a movable needle and marks or increments corresponding to the gauge reading.

In addition to analog barrel gauges and other analog instruments, vehicle information displays may also include digital or LED displays/readouts, and sometimes combine the analog and digital devices to vary the aesthetic look of an instrument panel. Additionally, various light-projection or reflection devices may be used, such as heads-up displays or HUD devices which reflect an image into a limited area utilizing cathode ray tubes (CRT), liquid crystals, lasers, and/or other devices suitable for projecting vehicle information into the driver's field of view. However, such devices, being generally limited to one-dimensional projection onto a flat reflective screen, may be less than optimal for certain purposes.

Modern vehicles may include an associated or linked gauge or indicator lamp providing information on one of many different vehicle subsystems which may in turn require an additional amount of space on the instrument panel. For example, warning lights describing potential engine or transmission performance issues, battery charge status, open doors, low tire pressure, anti-lock braking status, and/or regenerative braking status all must fit within a limited amount of space within an instrument panel, and often require the use of multiple indicator lights or gauges, which in turn may result in undesirable crowding of the instrument panel.

### SUMMARY OF THE INVENTION

Accordingly, an apparatus is provided that is usable for displaying information within a vehicle interior. The display system includes a display surface having a coating that emits visible light when excited by an ultraviolet (UV) light beam having a predetermined wavelength, and a laser projection device (LPD) for generating and for projecting the UV light beam onto the coating. The information is displayed on the display surface when visible light is emitted by the coating.

In one aspect of the invention, the LPD includes one or more UV lasers operable for generating the UV light beam.

In another aspect of the invention, the LPD includes a plurality of UV laser devices each configured for generating a different UV laser beam, with each UV laser beam having a different predetermined wavelength, and wherein the coating has a plurality of light-emitting layers each being excitable by a different one of the UV laser devices.

In another aspect of the invention, each of the light-emitting layers emits a different color of visible light when exited by a UV laser device.

In another aspect of the invention, the surface is a transparent windshield or a transparent instrument panel lens.

In another aspect of the invention, the display surface is an opaque surface portion of the vehicle interior.

In another aspect of the invention, the information is selected from the group of regenerative braking system status, message status, lighting status, HVAC system status, navigation system status, range information, road conditions, and climate condition.

In another aspect of the invention, a display system for a vehicle interior includes a display surface and a coating that is applied to the display surface. The coating contains light-emitting material for emitting visible light to display the information when the coating is excited by a UV light beam having a predetermined wavelength. The display system also includes a laser projection device (LPD) having at least one UV laser for generating the UV light beam, with the LPD being operable for projecting the UV light beam onto the coating.

In another aspect of the invention, the LPD has an equal number of UV lasers and light-emitting layers, and each UV laser excites a different one of the light-emitting layers.

In another aspect of the invention, a method is provided for displaying information within a vehicle interior. The method includes applying a light-emitting coating to a surface of the vehicle interior, and then generating and projecting the UV light beam onto the coating to cause the information to be displayed on the display surface.

In another aspect of the invention, the method includes applying the coating in two light-emitting layers each configured for emitting a different color of visible light when excited, generating two UV light beams of different wavelengths, and projecting the two UV light beams at different light-emitting layers. A first set of information is displayed on one light-emitting layer in a first color, and a second set of information is displayed on the other light-emitting layer in a second color.

In another aspect of the invention, the method includes setting the first set of information equal to the second set of information, and superimposing the sets to thereby simultaneously present the two sets of information in a third color.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is schematic representation of a vehicle having a display system according to the invention;

FIG. 2 is a schematic representation of the display system of the invention; and

FIG. 3 is a perspective view of an instrument panel of the vehicle of FIG. 1 configured with various embodiments of the display system of the invention.

### DESCRIPTION OF THE PREFERRED EMBODIMENTS

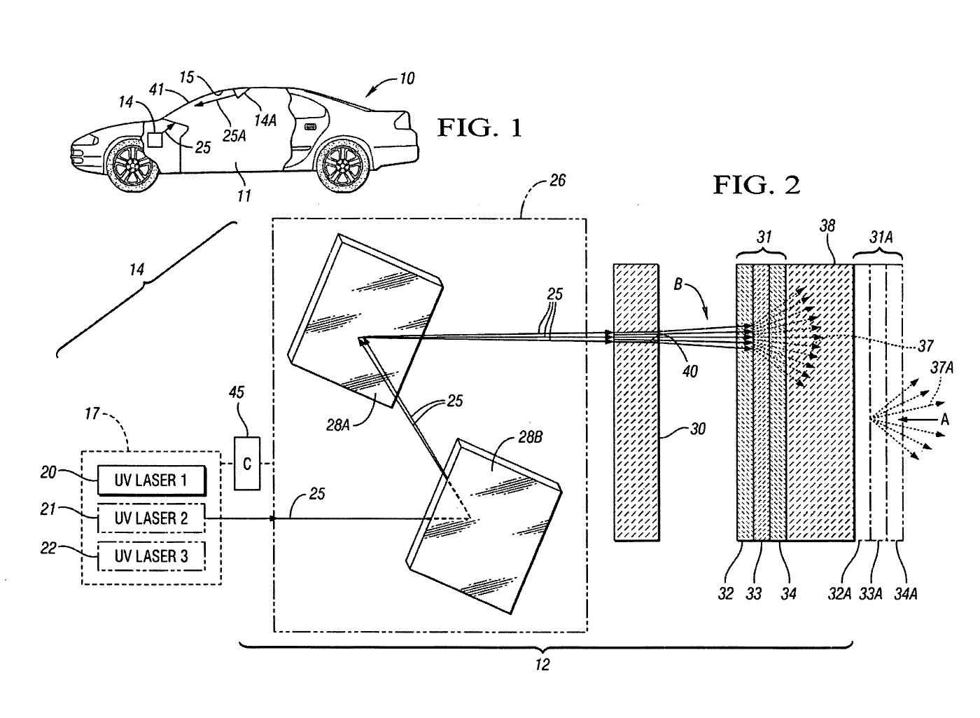

Referring to FIG. 1, wherein like reference numerals refer to like components throughout the several figures, a vehicle 10 includes a passenger compartment or vehicle interior 11 having a roof portion or headliner 15, and a dashboard or instrument panel 13. The instrument panel 13 is positioned adjacent to a windshield 41 and contains or houses any number of vents, gauges, controls, panels, or other such devices or surfaces, as will be described in detail below with reference to FIG. 2.

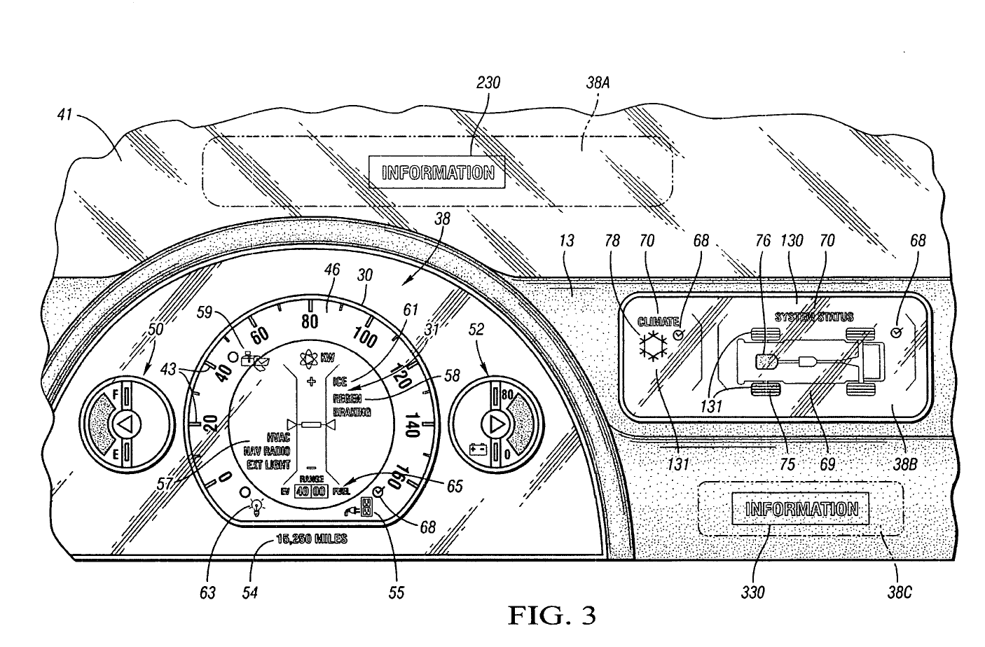

Within the vehicle interior 11, a display system 12 (see FIG. 2) of the invention is configured for presenting or displaying various data or information relating to a status or condition of the vehicle 10, and/or other information that may be of interest to an occupant of the vehicle 10, as will be described below with reference to FIG. 3. The display system 12 (see FIG. 2) includes a laser projection device or LPD 14 that is positioned behind the instrument panel 13, and that is operable for generating and for precisely projecting or directing a light beam 25 toward the instrument panel 13.

The display system 12 (see FIG. 2) may also or alternately include a substantially similar LPD 14A that is directly or indirectly mounted to or housed within the vehicle headliner 15, and that is sufficiently shielded and/or positioned to minimize or prevent direct viewing of a light beam 25A generated by the LPD 14A. The LPD 14A is operable for generating and precisely directing a light beam 25A onto any convenient display surface, such as the windshield 41 and/or an opaque surface portion of the instrument panel 13, as will be described in more detail with reference to FIG. 3.

Referring to FIG. 2, the display system 12 presents various information to an operator or user of the vehicle 10 (see FIG. 1) in a particular color, and in a format that may be layered and/or reconfigured as desired, as will be explained in detail hereinbelow. As used herein, the term “information” refers to any measurable or detectable status or condition of a system or sub-system of the vehicle 10 (see FIG. 1), including but not limited to a battery, fuel tank, regenerative braking system, wheels/tires, transmission, engine, navigation system, entertainment systems, and/or a heating, ventilation, and air conditioning (HVAC) system. The term “information” may also refer to any measurable or detectable environmental conditions, for example an outside temperature, climate, and/or road surface condition, as well as any externally generated information, such as wireless communications, electronic messages, or other such transmitted information.

In order to present the information to an occupant of the vehicle 10 (see FIG. 1), the display system 12 includes the LPD 14 and/or the LPD 14A, and an illuminable display 31. The LPD 14, 14A includes a light device 17 which has a light source 20 configured for generating a beam of light 25, 25A. The light device 17 may also include any number of additional light sources, which are shown in phantom in FIG. 2 as the light sources 21 and 22. Within the scope of the invention, the term “light beam” refers to a concentrated beam of electromagnetic energy, such as one or more ultraviolet (UV) lasers as explained below, having a predetermined wavelength.

The illuminable display 31 includes at least one light-emitting layer 32, but may also include additional light-emitting layers, represented in FIG. 2 as light-emitting layers 33 and 34. While three light-emitting layers 32, 33, and 34 are described herein, any number of light-emitting layers may be provided within the scope of the invention depending on the design of the vehicle 10 (see FIG. 1). The light-emitting layers 32, 33, and 34 are applied a coating, such as a single-layer or a multi-layered film, to either side of a display surface 38.

Within the scope of the invention, the display surface 38 may be any suitable transparent surface within the vehicle interior 11 (see FIG. 1) when the coating forming the illuminable display 31 is applied or attached to a side of the display surface that is opposite that of an occupant having the perspective of arrow A. Alternately, as shown in phantom, the display surface 38 may also be any suitable opaque surface of the vehicle interior 11, such as when the illuminable display 31A is applied or attached to the same side of display surface 38 as an occupant having the perspective of arrow A, as will be explained below with reference to FIG. 3. For simplicity, unless otherwise specified only the non-phantom elements of FIG. 2 will be discussed, with the explanation also applying to the phantom elements unless otherwise specified.

In accordance with the invention, each of the light-emitting layers 32, 33, 34 are configured for illuminating or emitting visible light of a particular wavelength or color in response to excitation by the respective light beam 25. In this manner, information may be presented as a text and/or an image, represented in FIG. 2 by the arrows 37 (or arrows 37A), and is readily visible on or through the display surface 38 from the perspective of arrow A. The image (arrows 37) may have a variable property such as brightness, intensity, color, and/or streaming or changing position in response to variations in an applied position and wavelength of the light beam 25, which may be a varied as a function of the combined applied wavelengths of the selected light sources 20, 21, and 22 when more than one light source 20, 21, 22 is used to form the light beam 25.

For optimal performance and clarity, the display surface 38 should be substantially seamless, and may be constructed of acrylic, plastic, vinyl, leather, glass, or another appropriate material shaped to form a surface that is suitable for the application. For example, as shown in FIG. 3, the display surfaces 38 or 38B may be transparent as described above, and configured for protecting a gauge 30 or a display 130, respectively, from dust and/or tampering, while at all times providing full visibility of the gauge 30 or the display 130 when viewed from the perspective of arrow A (see FIG. 2). Likewise, in another embodiment the display surface 38A may be a portion of the windshield 41 (see FIGS. 1 and 3), and/or an opaque surface portion or section of the instrument panel 13 as with the display surface 38C.

Still referring to FIG. 2, the projected image (arrows 37) may provide information that is separate from or supplementary to any information contained on or presented by the gauge 30 or other gauges in the instrument panel 13, without affecting the visibility or utility thereof. To an observer having the perspective of arrow A, the information, represented as the image (arrows 37) which is generated or excited within one or more of the light-emitting layers 32, 33, 34 may be made to appear to “float” above the gauge 30 on or within the various light-emitting layers 32, 33, 34 of the display surface 38, with this “layering effect” providing a reconfigurable or customizable information display capability.

The light-directing capability or precision of the LPD 14 may be optimized using a controllable light-directing device 26 which may include a pair of mirrors 28A, 28B. The mirrors 28A, 28B may be micro-mirrors of the type known in the art that are orthogonally moveable in a precise manner in response to a control signal from an integrated control unit or controller 45. For example, the mirrors 28A, 28B may be configured and/or shaped to accurately scan or direct the light beam 25 in various directions as needed. As the light beam 25 is redirected by the mirrors 28A, 28B, the light beam 25 begins to diverge or spread out. A hole 40 formed in the gauge 30 allows the diverging light beam 25 to pass through, and to continue to diverge as represented by arrow B. The light beam 25 then excites, illuminate, or “paints” one or more selected layers of the light-emitting layers 32, 33, and 34 to thereby form and project a highly detailed, visible image, as represented by the dotted arrows 37, at or upon each light-emitting layer 32, 33, and/or 34.

As will be appreciated by those of ordinary skill in the art, the electromagnetic spectrum is a continuous range of electromagnetic wavelengths and associated frequencies, with the electromagnetic spectrum ranging from extremely low frequency/long wavelength radio waves to ultra-high frequency/short wavelength gamma waves. Visible light, i.e. the band of electromagnetic energy that is perceptible by a human retina, generally includes electromagnetic waves of approximately 400 to 700 nanometers (nm), with narrower wavelength bands within this larger band being representative of a specific perceptible color. While the invention is not intended to be limited to any particular band or portion of the electromagnetic spectrum, the electromagnetic bandwidth comprising the ultraviolet (UV) spectrum may provide optimal utility when used to excite a visible image (arrows 37) within the illuminable display 31. Therefore, the light sources 20, 21, and 22 are shown in FIG. 2 as UV Lasers 1, 2, and 3, respectively.

The light sources 20, 21, and 22 may each generate a light beam of unique or sufficiently separated wavelengths. When using multiple light-emitting layers 32, 33, 34, each of the light-emitting layers 32, 33, and 34 has a corresponding light source 20, 21, or 22. That is, each of the light-emitting layers 32, 33, and 34 is excitable by only one of the available light sources 20, 21, and 22, and is not excitable by any of the remaining available light sources 20, 21, and 22. The wavelengths of each of the light sources 20, 21, and 22 therefore are sufficiently different to sufficiently minimize excitation of a particular light-emitting layer 32, 33, and/or 34 by more than one of the light sources 20, 21, or 22. For example, each of the light sources 20, 21, and 22 may be a UV laser selected from a different one of the known UVA, UVB, and UVC ranges in order to produce sufficient wavelength separation, or alternately may be selected from a common UV classification if sufficiently separated in wavelength.

To provide sufficient light-emitting capability to the illuminable display 31, each of the light-emitting layers 32, 33, and 34 of the illuminable display 31 may contain light-emitting nanoparticles, i.e. particles smaller than the approximately 400 nanometer (nm) lower wavelength limit of the visible light spectrum. Different proprietary light-emitting coatings, such as those disclosed by Superimaging, Inc. of Fremont, Calif., or similar light-emitting coatings may be used as the film or coating made up of the light-emitting layers 32, 33, and/or 34. Each of the light sources 20, 21, and 22 is therefore configured to generate a unique electromagnetic wavelength, which when directed onto a corresponding one of the light-emitting layers 32, 33, and 34, will excite the nanoparticles contained therein to produce a unique image color, brightness, and/or image intensity.

Additionally, by alternating or selecting the specific light-emitting layer 32, 33, and 34 that is to be excited or illuminated to present a particular set of information, or alternately by providing a sufficient amount of separation or distance between each of the light-emitting layers 32, 33, 34, such as by interposing a layer of transparent material (not shown) between each light-emitting layer 32, 33, and 34, one may achieve a ‘stacked’ or layered display effect. For example, vehicle status information having a higher or more immediate assigned information priority may be presented on a light-emitting layer 32, 33, or 34 having a particular color, such as red. Less immediate information may be presented in a different color, such as blue.

Likewise, if two or more light-emitting layers 32, 33, and 34 are used, a number of colors greater than the number of light-emitting layers 32, 33, and 34 used may be enabled by superimposing or simultaneously generating images on the light-emitting layers 32, 33, and/or 34. For example, by simultaneously exciting a blue layer with one light source 20, 21, or 22, and a red layer with a different light source 20, 21, or 22, the information may be presented in a purple color without requiring a dedicated purple-emitting layer.

The combination of the selected light-emitting layers 32, 33, and/or 34 and light sources 20, 21, and 22 may also be controllably varied using the controller 45 (see FIG. 2) to produce a dynamic or “streaming” display appearance, which may provide a visually appealing, more informative, and/or attention-commanding display. The display system 12 may be easily reconfigurable by reprogramming the controller 45 to achieve a desired visual effect, with the display system 12 usable across or incorporated into different vehicle designs.

In the embodiment of FIGS. 2 and 3, each of the light sources 20, 21, and 22 are UV lasers, however other light sources such as mercury discharge tubes or laser diodes are also usable within the scope of the invention. Field sequential addressing may be used to sequentially activate each respective light source 20, 21, and 22 as needed, thereby illuminating or “painting” the desired image on one or more of the light-emitting layers 32, 33, and 34 in response to signals or commands from the controller 45.

Referring now to FIG. 3, the gauge 30 is shown positioned within a vehicle instrument panel 13 adjacent to the windshield 41, with a steering wheel omitted for clarity. The gauge 30 as shown is an exemplary analog or digital speedometer 46 having speed increments 43 arranged in ascending order in the conventional fashion, with an additional and similarly configured vehicle battery charge gauge 52 and fuel gauge 50 flanking the speedometer 46. Although a speedometer 46 is shown for the purposes of illustration, those skilled in the art will recognize that other gauges may be usable within the scope of the invention.

The illuminable display 31 (also see FIG. 2) may be positioned adjacent to/above the gauge 30 with respect to an operator or occupant of the vehicle, presents or projects various data or information relating to vehicle status or other information that may be of interest to an occupant of the vehicle. For example, the illuminable display 31 may simultaneously or intermittently present regenerative braking system status 58, HVAC/radio/navigation system and/or headlight status 57, and/or e-mail or other message status 59. The surface 38 in this embodiment acts as a transparent lens housed within the instrument panel 13, as described above.

The illuminable display 31 may also present the remaining range-to-empty/discharge information 65, accessory recharge status 55, interior light status 63, detected road conditions 61, odometer reading 54, and/or whatever other selected desired vehicle status information a user may elect to have projected onto the illuminable display 31 of the display surface 38 (see FIG. 2). As shown, the gauge 30 is in a fixed or static position, with illuminable display 31 being projected or presented onto the display surface 38 so that certain information, for example e-mail status 59 and interior light status 63, may appear as a superimposed or layered image that is simultaneously viewable along with the information presented on gauge 30.

An additional display 130 may also be provided at a separate position viewable by both a driver and a passenger seated in a front passenger seat (not shown), for example at a position on the vehicle instrument panel 13 approximately midway between the driver and passenger. The display 130 may also contain various fixed and/or static information, such as a vehicle silhouette or outline 69 and/or associated status messages 70. Another display 131 may be positioned with respect to the additional display 130 and configured for conveying or presenting information pertaining to vehicle or environmental status information that may be of interest to both a passenger and a driver of a vehicle.

For example, an exemplary engine outline or schematic 76 and left front tire outline or schematic 75 may be projected onto a transparent substrate 38B above the vehicle schematic or outline 69 to present in a graphical manner a “check engine” or “low tire pressure” warning typically presented via static or fixed warning lights or lamps, while climate conditions 78 present graphically the status of the vehicle's air conditioning system, and/or inside/outside temperatures. Optional on/off status indicators 68 may also be included on either or both of the gauge 30 and display 130 to allow a driver or passenger of the vehicle 10 (see FIG. 1) to quickly determine whether the associated vehicle system is active.

Other displays 230 and/or 330 may also be respectively projected onto the windshield 41 or a display surface 38C of the instrument panel 13, to which one or more of the light-emitting layers 32, 33, and/or 34 (see FIG. 2) may be applied. The displays 230 and/or 330 are viewable by both a driver and a passenger of the vehicle 10 (see FIG. 1). When projecting onto the windshield 41 and/or the instrument panel 13, the LPD 14A (see FIGS. 1 and 2) may be used to generate and project the light beam 25A (see FIGS. 1 and 2) rather than the LPD 14 to minimize physical interference with or obstruction of the path of the light beam 25A by occupants of the vehicle.

While the best modes for carrying out the invention have been described in detail, those familiar with the art to which this invention relates will recognize various alternative designs and embodiments for practicing the invention within the scope of the appended claims.

1. An apparatus for displaying information within a vehicle interior, the apparatus comprising:
a display surface having a coating that is adapted for emitting visible light when said coating is excited by an ultraviolet (UV) light beam having a predetermined wavelength; and
a laser projection device (LPD) operable for generating said UV light beam and for directing said UV light beam onto said coating;
wherein the information is displayed on said display surface when said visible light is emitted by said coating.

2. The apparatus of claim 1, wherein said LPD includes at least one UV laser device operable for generating said UV light beam.

3. The apparatus of claim 2, wherein said LPD includes a plurality of UV laser devices each being configured for generating a different UV laser beam each having a different predetermined wavelength, and wherein said coating has a plurality of light-emitting layers each being excitable by a different one of said plurality of UV laser devices.

4. The apparatus of claim 3, wherein each of said plurality of light-emitting layers emits a different color of visible light when excited by one of said plurality of UV laser devices.

5. The apparatus of claim 1, wherein said surface is transparent, and is selected from the group of a windshield and an instrument panel lens.

6. The apparatus of claim 1, wherein said surface is an opaque surface portion of the vehicle interior.

7. The apparatus of claim 1, wherein the information is selected from the group of regenerative braking system status, message status, lighting status, HVAC system status, navigation system status, range information, road conditions, and climate condition.

8. A display system for a vehicle interior comprising:
a display surface;
a coating that is applied to said display surface and adapted for emitting visible light when excited by an ultraviolet (UV) light beam having a predetermined wavelength, said coating having at least one light-emitting layer containing a light-emitting material; and
a laser projection device (LPD) having at least one UV laser operable for generating said UV light beam and for projecting said UV light beam onto said coating;
wherein said visible light that is emitted from said coating displays information on said display surface.

9. The display system of claim 8, said LPD being configured with an equal number of said UV lasers and said light-emitting layers;
wherein each of said UV lasers is configured for exciting a different one of said light-emitting layers.

10. The display system of claim 8, wherein said display surface is a transparent lens adapted for covering an instrument gauge that is housed within an instrument panel of the vehicle interior.

11. The display system of claim 8, wherein said display surface is a windshield.

12. The display system of claim 8, wherein said display surface is an opaque surface portion of an instrument panel of the vehicle interior.

13. A method for displaying information within a vehicle interior, the method comprising:
applying a coating to a display surface of the vehicle interior, said coating being configured for emitting visible light when excited by an ultraviolet (UV) light beam having a predetermined wavelength;
generating said UV light beam; and
projecting said UV light beam onto said coating to thereby excite said coating to emit said visible, thus causing the information to be displayed on said display surface using said visible light.

14. The method of claim 13, further comprising:
generating a first UV light beam having a first UV wavelength;
generating a second UV light beam having a second UV wavelength that is different from said first UV wavelength;
providing said coating with a first light-emitting layer configured for emitting a first color of said visible light when excited by said first UV light beam, and with a second light-emitting layer configured for emitting a second color of said visible light when excited by said second UV light beam;
projecting said first UV light beam onto said first light-emitting layer to cause a first set of the information to be presented on said first light-emitting layer in said first color; and
projecting said second UV light beam at said second light-emitting layer to cause a second set of the information to be presented on said second light-emitting layer in said second color.

15. The method of claim 14, further comprising:
setting said first set of information equal to said second set of information; and
super-imposing said first set of information and said second set of information to thereby simultaneously present said first and said second sets of information in a third color.
